(19) United States
(12) Patent Application Publication
(10) Pub. No.: US 2017/0175604 A1
(43) Pub. Date: Jun. 22, 2017

(54) SYSTEM AND METHOD TO IMPROVE NOX CONVERSION FROM A HYBRID POWER PLANT

(71) Applicant: General Electric Company, Schenectady, NY (US)

(72) Inventors: Maruthi Narasinga Rao Devarakonda, Waukesha, WI (US); Michael Url, Neufahrn b. Freising (DE); Constantin Dinu, Greer, SC (US)

(21) Appl. No.: 14/978,434

(22) Filed: Dec. 22, 2015

(51) Int. Cl. F01N 3/20; F01N 13/00; F02C 7/26; F01N 11/00

(52) U.S. Cl. CPC F01N 3/208; F01N 11/002; F01N 13/008; F02C 7/26; F01N 2550/02; F01N 2560/06; F01N 2900/1404; F01N 2900/0602; F05D 2220/32; F05D 2220/74; F05D 2270/082

(57) ABSTRACT

A system includes a nitrous oxide (NOx) conversion system configured to treat emissions from a conversion system, and includes a selective catalytic reduction (SCR) catalyst assembly and a temperature sensor disposed upstream of the SCR catalyst assembly to measure temperature of an exhaust before flowing into the SCR catalyst assembly. The NOx conversion system includes a temperature sensor downstream of the SCR catalyst assembly to measure a temperature of a treated exhaust flow after exiting the SCR catalyst assembly and a controller coupled to the SCR catalyst assembly. The controller receives signals representative of the temperatures to generate a first control signal representative of a desired temperature to heat the exhaust to. The controller receives the first control signal to output a second control signal to regulate a temperature of the exhaust upstream of the SCR catalyst assembly via a heating system.

### BACKGROUND

The subject matter disclosed herein relates to an aftertreatment system (e.g., exhaust treatment) and, more specifically, an aftertreatment system for a hybrid power plant.

Hybrid power plants (e.g., including a combination of internal combustion engines such as gas engines and gas turbines) generate power utilizing a combination of different resources. These resources may generate various emissions (e.g., nitrogen oxides (NOₓ)). As such, there is a need to reduce the level of emissions generated by the hybrid power plant.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In a first embodiment, a system includes a nitrous oxide (NOx) conversion system configured to treat emissions from a hybrid power plant, where the NOx conversion system includes a selective catalytic reduction (SCR) catalyst assembly and at least one temperature sensor disposed upstream of the SCR catalyst assembly configured to measure a first temperature of an exhaust flow prior to flowing into the SCR catalyst assembly. The NOx conversion system includes at least one temperature sensor disposed downstream of the SCR catalyst assembly configured to measure a second temperature of a treated exhaust flow after exiting the SCR catalyst assembly and a first controller communicatively coupled to the SCR catalyst assembly, where the first controller is programmed to receive signals representative of the first and second temperatures to generate, based at least on the signals representative of the first and second temperatures, a first control signal representative of a desired temperature to heat the exhaust flow to prior to flowing into the SCR catalyst assembly. The NOx conversion system includes a second controller communicatively coupled to the first controller, where the second controller is programmed to receive the first control signal to output a second control signal and to regulate a temperature of the exhaust flow upstream of the SCR catalyst assembly via a heating system.

In a second embodiment, a system includes a heating system and a nitrous oxide (NOx) conversion system configured to treat emissions a hybrid power plant, where the NOx conversion system includes an oxidation catalyst assembly and at least one temperature sensor disposed upstream of the oxidation catalyst assembly configured to measure a first temperature of an exhaust flow prior to flowing into the oxidation catalyst assembly. The NOx conversion system includes at least one temperature sensor disposed downstream of the oxidation catalyst assembly configured to measure a second temperature of a treated exhaust flow after exiting the oxidation catalyst assembly and a first controller communicatively coupled to the oxidation catalyst assembly, where the first controller is programmed to receive signals representative of the first and second temperatures and to generate based at least on the signals representative of the first and second temperatures a first control signal representative of a desired temperature to heat the exhaust flow to prior to flowing into the oxidation catalyst assembly. The NOx conversion system includes a second controller communicatively coupled to the first controller, where the second controller is programmed to receive the first control signal and to output a second control signal to regulate a temperature of the exhaust flow upstream of the oxidation catalyst assembly via a heating system.

In a third embodiment, a method for operating a hybrid power plant having a gas turbine engine and a gas engine includes receiving a first signal representative of a first temperature of an exhaust flow from at least the gas engine prior to flowing into a catalyst assembly at a first controller. The method includes receiving a second signal representative of a second temperature of a treated exhaust flow after exiting the catalyst assembly at the first controller. The method includes generating a first control signal, via the first controller, representative of a desired temperature to heat the exhaust flow to prior to flowing into the catalyst assembly. The method includes generating a second control signal, via a second controller, to regulate a temperature of the exhaust flow prior to flowing into the catalyst assembly based on the first control signal. The method includes regulating, based on the second control signal, the temperature of the exhaust flow prior to flow into the catalyst assembly, via a heating system, by heating the exhaust flow with a gas turbine exhaust flow from the gas turbine.

### BRIEF DESCRIPTION OF THE DRAWINGS

These and other features, aspects, and advantages of the present subject matter will become better understood when the following detailed description is read with reference to the accompanying drawings in which like characters represent like parts throughout the drawings, wherein:

FIG. 1 is a schematic diagram of an embodiment of an exhaust treatment (e.g., aftertreatment) system coupled to an engine of a hybrid power plant;

FIG. 2 is a block diagram of an embodiment of a controller (e.g., an electronic control unit (ECU));

FIG. 3 is a schematic diagram of the functional operation of the controller to control and/or monitor the heating system of FIG. 1; and

FIG. 4 is a flow chart of an embodiment of a computer-implemented method for controlling an amount of heat transferred to an exhaust flow upstream of a catalyst assembly.

### DETAILED DESCRIPTION

One or more specific embodiments of the present subject matter will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present subject matter, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is directed to systems and methods that utilize aftertreatment systems (e.g., oxidation catalysts or selective catalyst reduction (SCR)) for reduction of emissions from engine exhaust flows emitted from a hybrid power plant (e.g., exhaust flows from a gas turbine engine, gas (e.g., piston) engine, etc.). In particular, embodiments of the present disclosure utilize a nitrous oxide (NOₓ) conversion system having a heating system to control the temperature of the gas engine exhaust. It will be appreciated the gas engine exhaust may be heated directly or indirectly. The NOₓ conversion system includes a catalyst assembly (e.g., an oxidation catalyst, an SCR catalyst assembly) disposed downstream of the engine exhaust. One or more temperature sensors are disposed upstream and downstream of the catalyst assembly. The NOₓ conversion system includes one or more controllers. The controllers are configured to communicatively couple to the catalyst assembly. In one example, a first controller is programmed to receive signals representative of a temperature of the exhaust flows upstream of the catalyst assembly and the temperature of a treated exhaust flow downstream of the catalyst assembly. One or more temperature sensors may be disposed upstream of the catalyst assembly and downstream of the catalyst assembly. The first controller may generate a control signal (e.g., first control signal) which corresponds to a desired temperature to heat the exhaust flow to prior to the exhaust flow flowing into the catalyst assembly. The first control signal may include averaging the first temperatures (e.g., temperature of the exhaust flows upstream of the catalyst assembly) and the second temperatures (e.g., the temperature of a treated exhaust flow downstream of the catalyst assembly). The desired temperature may be based at least in part on the desired emissions (e.g., NOₓ, CO) conversion level. A second controller may be communicatively coupled to the first controller. The second controller may be programmed to output a second control signal to regulate a temperature of the exhaust flow upstream of the catalyst assembly via a heating system. The heating system may include a heater, boiler, thermal storage media, or any other suitable heating equipment. In some embodiments, the first control signal and the second control signal may be generated by the same controller. In other words, a single controller may be utilized to control the temperature of the exhaust flow prior to entering the catalyst assembly and the temperature of the treated exhaust flow exiting the catalyst assembly. By controlling the temperature of the exhaust flow flowing into the catalyst assembly (e.g., oxidation catalyst, SCR catalyst), the level of NOₓ conversion can be controlled to achieve a desired conversion level.

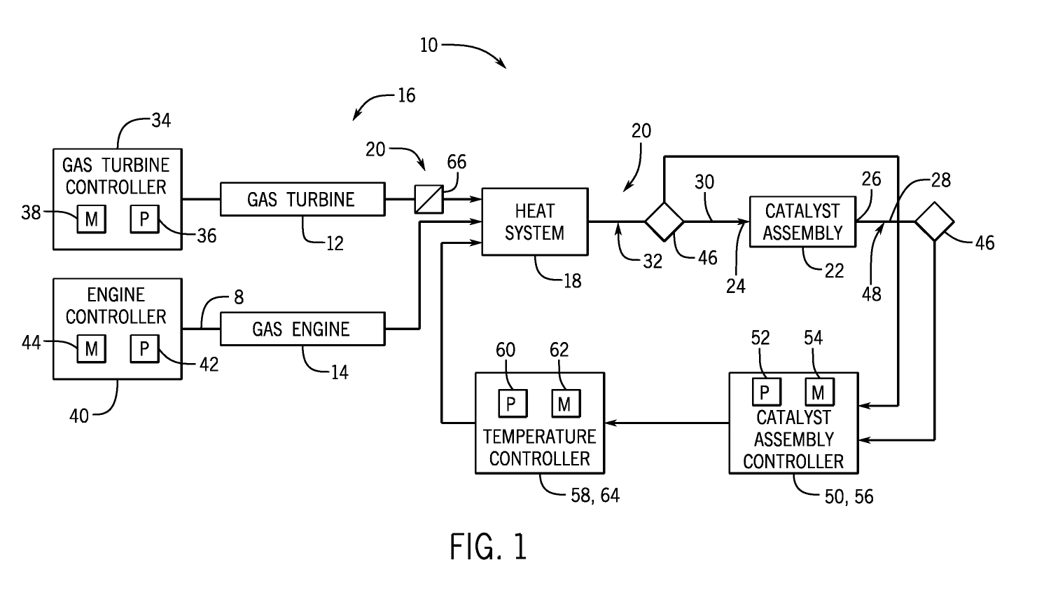

Turning now to the figures, FIG. 1 is a schematic diagram of an embodiment of an exhaust treatment (e.g., aftertreatment) system 10 coupled to one or more gas turbine engines 12 and one or more gas (e.g., piston) engines of a hybrid power plant 16. As described in detail below, the disclosed exhaust treatment system 10 includes a heating system 18 to control or regulate the temperature of exhaust 20 flowing into a catalyst assembly 22 (e.g., oxidation catalyst assembly, SCR catalyst assembly). During operation, the engines (e.g., gas turbine engine 12, gas (e.g., piston) engine 14) generate combustion gases used to apply a driving force to a component of the engines 12, 14 (e.g., one or more turbines or pistons). The combustion gases subsequently exit the engines 12, 14 as the exhaust gases 20, which includes a variety of emissions (e.g., NOₓ, hydrocarbons, CO, etc.). The exhaust treatment system 10 treats these emissions to generate milder emissions (nitrogen (N₂), carbon dioxide (CO₂), water, etc). As depicted, the exhaust treatment system 10 includes catalytic converters or catalysts assemblies, such as the catalyst assembly 22. In embodiments that include the catalyst assembly 22, the engines 12, 14 may be operated as a lean-burn engine, generating NOₓ emissions requiring reduction or other treatment via the catalyst assembly 22. The catalyst assembly 22, via its catalytic activity, reduces CO, HC, and NOₓ via multiple reactions. For example, NOₓ may be reduced via a gaseous reductant (e.g., urea) to generate N₂, CO₂, and H₂O, and NOₓ may be reduced via anhydrous or aqueous ammonia to generate N₂ and H₂O. Several secondary reactions may occur with anhydrous or aqueous ammonia resulting in ammonia sulfate and ammonia hydrogen sulfate. The catalyst assembly 22 includes an inlet 24 to receive the exhaust flows 20 from the hybrid power plant 16. The exhaust flows 20 may include exhaust from the gas turbine engine 12, the gas (e.g., piston) engine 14, or both. The catalyst assembly 22 (e.g., oxidation catalyst assembly, SCR catalyst assembly) includes an outlet 26 to discharge an aftertreatment fluid 28 via the catalyst outlet 26. A fluid conduit 30 may fluidly couple the heating system 18 to the catalyst assembly 22. The fluid conduit 30 may also fluidly couple the exhaust flows 20 from the gas turbine engine 12 and the gas engine 14 to the heating system 18. Other equipment (e.g., a mixer or other operating equipment) may be present between the engines 12, 14 and the heating system 18 and/or the catalyst assembly 22 to prepare the catalyst assembly 22 for receiving the exhaust flows 20. The heating system 18 may include a heater, a boiler, a thermal storage media (e.g., metal hydride thermal storage), or other similar equipment to affect the temperature of the exhaust flows entering the catalyst assembly 22. In some embodiments, the after treatment system 10 may include a bypass 66 to direct the exhaust from the gas turbine engine 12 away from the heating system 18.

The heating system 18 may be used to control the amount of heat (e.g., stored heat) is transferred to the exhaust flows 20 upstream 32 of the catalyst assembly 22. If the engines 12, 14 are operating under a richer fuel condition, the amount of heat transferred from the heating system 18 may be greater than when one or both of the engines 12, 14 operates leaner. The amount of heat transferred from the heating system 18 may contribute to the NOₓ reduction level of the exhaust flows 20. When the engines 12, 14 produce fewer NOₓ emissions, a lesser amount of heat is injected via the heating system 18.

The gas turbine engine 12 may include a heavy duty gas turbine engine, aeroderivative gas turbine, steam turbine, or other turbine engines. The gas (e.g., piston) engine 14 may include an internal combustion engine such as a reciprocating engine (e.g., multi-stroke engine such as two-stroke engine, four-stroke engine, six-stroke engine, etc.). The engines 12, 14 may operate on a variety fuels (e.g., natural gas, diesel, syngas, gasoline, etc.). The gas turbine engine 12 may be coupled to an engine control unit (e.g., controller) 34 that controls and monitors the operations of the engine 12. The controller 34 includes processing circuitry (e.g., processor 36) and memory circuitry (e.g., memory 38). The processor 36 may execute instructions to carry out the operation of the engine 12. The gas engine 14 may be coupled to an engine control unit (e.g., controller) 40 that controls and monitors the operations of the engine 14. The controller 40 includes processing circuitry (e.g., processor 42) and memory circuitry (e.g., memory 44). The processor 42 may execute instructions to carry out the operation of the gas engine 14. The exhaust flows 20 from the various engines 12, 14 includes various emissions (e.g., NOₓ, hydrocarbons) which are output at various temperatures and flow rates. Other engine operating parameters 8 (e.g., engine speed, engine load, fuel quality) may also be monitored by the controller 40. Temperature sensors 46 are disposed along the conduit 30 to monitor temperatures of the exhaust flows 20 along the conduit 30. At least one temperature sensor 46 is disposed upstream 32 of the catalyst assembly 22. At least one temperature sensor 46 is disposed downstream 48 of the catalyst assembly 22. The temperature sensors 46 are communicatively coupled to a catalyst assembly controller 50. The catalyst assembly controller 50 includes processing circuitry (e.g., processor 52) and memory circuitry (e.g., memory 54). The catalyst assembly controller 50 receives temperatures of the exhaust flow 20 prior to entering the SCR catalyst assembly 22 and of the aftertreatment fluid 28. The catalyst assembly controller 50 may be communicatively coupled to a temperature controller 58, as described in detail below. The catalyst assembly controller 50 generates a first control signal 56. The first control signal 56 is based at least in part on the temperatures of the exhaust flow 20 prior to entering the catalyst assembly 22 and of the aftertreatment fluid 28 generated by the temperature sensors 46 and received by the catalyst assembly controller 50. The first control signal 56 is representative of a desired temperature at which the exhaust flow 20 are to be heated to such that a desired level of NOₓ emissions are reduced (e.g., a desired level of NOₓ conversion is achieved).

As described above, the catalyst assembly controller 50 (e.g., exhaust treatment controller) is communicatively coupled to the temperature controller 58. The temperature controller 58 includes processing circuitry (e.g., processor 60) and memory circuitry (e.g., memory 62). The temperature controller 58 receives the first control signal 56 from the catalyst assembly controller 50. The temperature controller 58 is programmed to generate a second control signal 64. The second control signal 64 generates an output command based at least in part on the first control signal 56. For example, the second control signal 64 may cause the heating system 18 to reduce, increase, or maintain the amount of heat transferred to the exhaust flow 20 upstream 32 of the catalyst 22 to regulate the temperature of the exhaust flow 20.

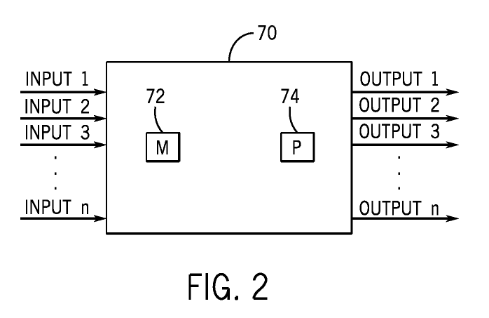

FIG. 2 is a block diagram of an embodiment of a controller 70. As mentioned above, the catalyst assembly controller 50 (e.g., exhaust treatment controller) generally outputs the first control signal 56 based at least in part on the on the temperature signals generated by the temperature sensors 46 which are representative of the temperatures of the exhaust flow 20 prior to entering the catalyst assembly 22 and of the aftertreatment fluid 28. The temperature controller 58 generates the second control signal 64 to reduce, increase, or maintain the amount of heat transferred from the heating system 18 to the exhaust flows 20 upstream 32 of the catalyst 22. In some embodiments, a single controller 70 may be used to accomplish the function of the catalyst assembly controller and the temperature controller 58. In other words, the single controller 70 may output the first control signal 56 and the second control signal 64.

The controller 70 (and similarly controllers 50, 58) includes non-transitory code or instructions stored in a machine-readable medium (e.g., memory 72) and used by a processor (e.g., processor 74) to implement the techniques disclosed herein. In certain embodiments, the controller 70 (controllers 50, 58) may utilize the memory 72 to store instructions (e.g., code) and the processor 74 (e.g., multiple microprocessors, one or more “general-purpose” microprocessors, one or more special-purpose microprocessors, and/or some other processor configuration) to execute the instructions. The memory 72 may store various tables and/or models (e.g., software models representing and/or simulating various aspects of the hybrid power plant 16, the heating system 18, and each engine 12, 14 of the hybrid power plant 16). In certain embodiments, the memory 72 may be wholly or partially removable from the controller 70. The controller 70 receives one or more input signals from sensors (input₁ . . . inputₙ) including engine inputs, and other components (e.g., user interface) of the hybrid power plant 16 and outputs one or more output signals (output₁ . . . outputₙ). The various input signals may include engine outputs (e.g., temperature, flow rate), emissions concentrations (e.g., NOₓ concentration), or other operating conditions of the hybrid power plant 16. The output signals may include an adjustment to an injection command (e.g., second control signal 64) to adjust the amount of heat transferred to the exhaust flows 20 prior to entering the SCR catalyst assembly 22 or another adjustment to the system. The controller 70 may utilize one or more types of models (e.g., software-based models executable by a processor). For example, the models may include statistical models, such as regression analysis models. Regression analysis may be used to find functions capable of modeling future trends within a certain error range. Association techniques may be used to find relationship between variables. Also, the data utilized with the models may include historical data, empirical data, knowledge-based data, and so forth.

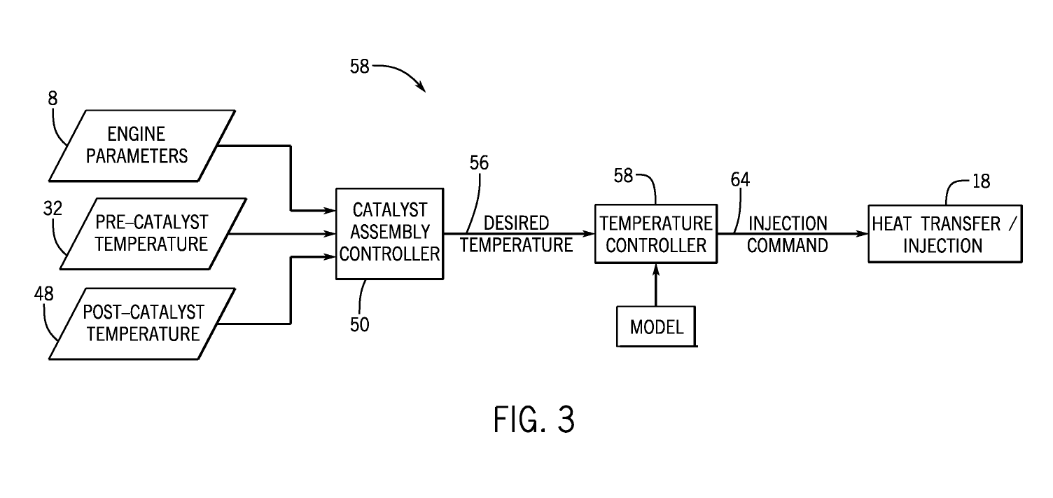

FIG. 3 is a schematic diagram of the functional operation of the controller 58 to control and/or monitor the heating system 18 of FIG. 1. The temperature of the exhaust flows 20 are measured via the temperature sensors 46 and utilized in the catalyst assembly controller 50. The output of the catalyst assembly controller 50 is communicated to the temperature controller 58. As depicted, the catalyst assembly controller 50 may receive signals from the temperature sensors 46 that are indicative of the temperature of the exhaust flows 20 upstream of the catalyst assembly 22 (e.g., upstream 32 of the catalyst assembly). The catalyst assembly controller 50 may receive signals from the temperature sensors 46 that are indicative of the temperature of the exhaust flows 20 downstream of the catalyst assembly 22 (e.g., downstream 48 of the SCR catalyst assembly). The catalyst assembly controller 50 may utilize one or more look up tables (LUT) stored in the memory 54 and a model to output the first control signal 56.

The amount of heat transferred from the heating system 18 is controlled by the second control signal 64 (e.g., injection command) output by the temperature controller 58. The temperature controller 58 receives the first control signal 56 (e.g., a desired temperature) from the catalyst assembly controller 50 to determine in part the second control signal 64. The second control signal 64 may determine the amount of heat that will be transferred from the heating system 18 to the exhaust flows 20 to achieve the desired level of NOₓ reduction. At any time during the operation, an operator may interrupt the automatic control sequence of the heating system 18 as described herein and manually change the operating parameters of the heating system 18, the catalyst assembly 22 (e.g., oxidation catalyst, SCR catalyst), the gas turbine engine 12, and/or the gas engine 14.

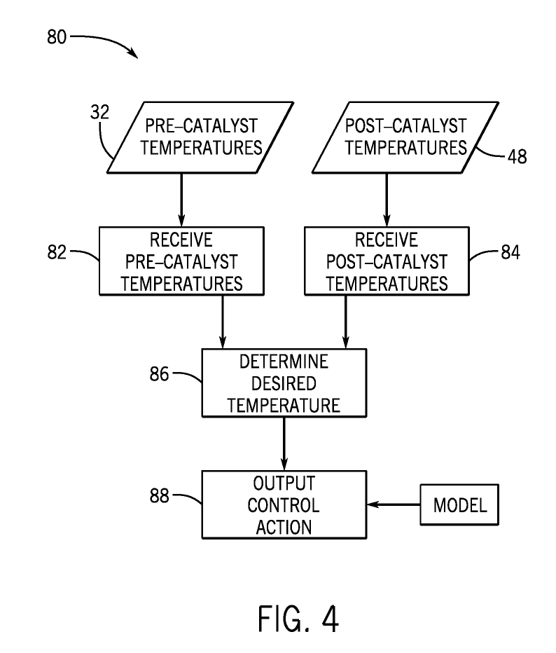

FIG. 4 is a flow chart of an embodiment of a computer-implemented method 80 for controlling an amount of heat transferred to an exhaust flow upstream of a catalyst assembly 22. All or some of the steps of the method 80 may be executed by the controllers 50, 58, 70. The method 80 may include receiving temperatures of the fluid (e.g., exhaust flows 20) upstream of the catalyst assembly (block 82) and/or receiving temperatures of the fluid (e.g., exhaust flows 20) downstream of the catalyst assembly (block 84). The method 80 includes using the catalyst assembly controller 56 to determine a desired temperature of the exhaust flows entering the catalyst assembly such that a desired level of NOx reduction is achieved (block 86). The method 80 includes using the desired temperature and a model to output a control action 64 to transfer an amount of heat such that the exhaust flows entering the catalyst assembly reach a desired temperature (block 88).

Technical effects of the subject matter include using a heating system to control the temperature of the exhaust flow flowing into the catalyst assembly. Controlling the temperature of the exhaust flows enables the level of NOₓ or other emissions conversion to be controlled to achieve a desired conversion level. One or more controllers may be used to generate a control signal (e.g., first control signal) which corresponds to a desired temperature to heat the exhaust flow to prior to the exhaust flow flowing into the catalyst assembly. The same or a second controller may be programmed to output a second control signal to regulate a temperature of the exhaust flow upstream of the catalyst assembly via a heating system. The heating system may include a heater, boiler, thermal storage media, or any other suitable heating equipment. The heating system may increase the level of emissions conversion to a desired level.

This written description uses examples to disclose the subject matter, including the best mode, and also to enable any person skilled in the art to practice the subject matter, including making and using any devices or systems and performing any incorporated methods. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a nitrous oxide nitrous oxide (NOx) conversion system configured to treat emissions from a hybrid power plant, wherein the NOx conversion system comprises:
a selective catalytic reduction (SCR) catalyst assembly;
at least one temperature sensor disposed upstream of the SCR catalyst assembly configured to measure a first temperature of an exhaust flow prior to flowing into the SCR catalyst assembly;
at least one temperature sensor disposed downstream of the SCR catalyst assembly configured to measure a second temperature of a treated exhaust flow after exiting the SCR catalyst assembly;
a first controller communicatively coupled to the SCR catalyst assembly, wherein the first controller is programmed to receive signals representative of the first and second temperatures and to generate based at least on the signals representative of the first and second temperatures a first control signal representative of a desired temperature to heat the exhaust flow to prior to flowing into the SCR catalyst assembly; and
a second controller communicatively coupled to the first controller, wherein the second controller is programmed to receive the first control signal and to output a second control signal to regulate a temperature of the exhaust flow upstream of the SCR catalyst assembly via a heating system.

2. The system of claim 1, wherein the hybrid power plant comprises a gas turbine engine and a gas engine.

3. The system of claim 2, wherein the exhaust flow is a gas engine exhaust flow.

4. The system of claim 3, wherein the heating system is configured to directly heat the gas engine exhaust flow with the gas turbine exhaust flow.

5. The system of claim 3, wherein the heating system is configured to indirectly heat the gas engine exhaust flow with gas turbine exhaust flow from the gas turbine engine.

6. The system of claim 2, wherein the heating system comprises a heater or thermal storage medium.

7. The system of claim 1, wherein the first controller is programmed to output the first control signal based on the signals representative of the first and second temperatures and a catalyst formulation of the SCR catalyst assembly.

8. The system of claim 1, wherein the first controller is programmed to identify an optimal temperature operating window for maximizing NOₓ conversion within the SCR catalyst assembly and to generate the first control signal based on the optimal temperature operating window.

9. The system of claim 1, wherein the first controller is programmed to utilize a model to generate the first control signal.

10. The system of claim 1, wherein the first controller is programmed to determine the first control signal by averaging the first and second temperatures.

11. A system, comprising:
a heating system; and
a nitrous oxide (NOx) conversion sytem configured to treat emissions from a hybrid power plant, wherein the NOx conversion system comprises:
an oxidation catalyst assembly;
at least one temperature sensor disposed upstream of the oxidation catalyst assembly configured to measure a first temperature of an exhaust flow prior to flowing into the oxdiation catalyst assembly;
at least one temperature sensor disposed downstream of the oxidation catalyst assembly configured to measure a second temperature of a treated exhaust flow after exiting the oxidation catalyst assembly;
a first controller communicatively coupled to the oxidation catalyst assembly, wherein the first controller is programmed to receive signals representative of the first and second temperatures and to generate based at least on the signals representative of the first and second temperatures a first control signal representative of a desired temperature to heat the exhaust flow to prior to flowing into the oxidation catalyst assembly; and
a second controller communicatively coupled to the first controller, wherein the second controller is programmed to receive the first control signal and to output a second control signal to regulate a temperature of the exhaust flow upstream of the oxidation catalyst assembly via a heating system.

12. The system of claim 11, wherein the hybrid power plant comprises a gas turbine engine and a gas engine.

13. The system of claim 12, wherein the exhaust flow is a gas engine exhaust flow, and the heating system is configured to directly heat the gas engine exhaust flow with gas turbine exhaust flow.

14. The system of claim 12, wherein the exhaust flow is a gas engine exhaust flow, and the heating system is configured to indirectly heat the gas engine exhaust flow with gas turbine exhaust flow from the gas turbine engine.

15. The system of claim 12, wherein the first controller is programmed to identify an optimal temperature operating window for maximizing NOₓ conversion within the oxidation catalyst assembly and to generate the first control signal based on the optimal temperature operating window.

16. A method for operating a hybrid power plant having a gas turbine engine and a gas engine comprising:
receiving a first signal representative of a first temperature of an exhaust flow from at least the gas engine prior to flowing into a catalyst assembly at a first controller;
receiving a second signal representative of a second temperature of a treated exhaust flow after exiting the catalyst assembly at the first controller;
generating a first control signal, via the first controller, representative of a desired temperature to heat the exhaust flow to prior to flowing into the catalyst assembly;
generating a second control signal, via a second controller, to regulate a temperature of the exhaust flow prior to flowing into the catalyst assembly based on the first control signal; and
regulating, based on the second control signal, the temperature of the exhaust flow prior to flow into the catalyst assembly, via a heating system, by heating the exhaust flow with a gas turbine exhaust flow from the gas turbine.

17. The method of claim 16, wherein regulating the temperature of the exhaust flow prior to flowing into the catalyst assembly, via the heating system, comprises indirectly heating the exhaust flow with the gas turbine exhaust flow.

18. The method of claim 16, wherein regulating the temperature of the exhaust flow prior to flowing into the catalyst assembly, via the heating system, comprises directly heating the exhaust flow with the gas turbine exhaust flow.

19. The method of claim 16, wherein generating the first control signal comprises averaging the first and second temperatures.

20. The method of claim 16, comprising identifying an optimal temperature window for maximizing NOₓ conversion within the catalyst assembly, and wherein generating the first control signal, via the first controller, comprises generating the first control signal based on the optimal temperature window.
